(19) United States
(12) Patent Application Publication
(10) Pub. No.: US 2026/0160492 A1
(43) Pub. Date: Jun. 11, 2026

(54) WASTE DRYING DEVICE AND WASTE DRYING METHOD

(71) Applicant: YUH SHAN ENVIRONMENTAL ENGINEERING CO., LTD., Kaohsiung City (TW)

(72) Inventors: Wen-Hsien TSAI, Kaohsiung City (TW); Kuan-Hung WU, Kaohsiung City (TW); Yuan-Hung LIU, Kaohsiung City (TW); Yu-Chi CHANG, Kaohsiung City (TW); Pin-Xu CHEN, Kaohsiung City (TW)

(21) Appl. No.: 19/251,851

(22) Filed: Jun. 27, 2025

(30) Foreign Application Priority Data
Dec. 10, 2024 (TW) 113147873

(51) Int. Cl. F26B 11/10; F26B 11/02; F26B 21/10; F26B 21/12

(52) U.S. Cl. CPC F26B 11/10; F26B 11/026; F26B 11/028; F26B 21/35; F26B 21/37; F26B 2200/04

(57) ABSTRACT

A waste drying device includes a reaction tank, an air compressor, an electric heating rod, and a debris prevention assembly. The reaction tank includes a housing, a hollow tube, and a plurality of hollow stirring rods. The housing has a waste drying space for accommodating an initial waste and a dried waste. The hollow tube is disposed on a sidewall of the housing and located inside the housing. The plurality of hollow stirring rods is disposed on an outer surface of the hollow tube and located in the housing. The air compressor is fluidly connected to the hollow tube. The heating rod is located in the hollow tube. The debris prevention assembly is disposed on the housing and fluidly connected to the waste drying space, and is configured to prevent the initial waste and/or the dried waste from flying out of the waste drying space.

### CROSS-REFERENCE TO RELATED APPLICATION

This application claims priority to Taiwan Application Serial Number 113147873, filed Dec. 10, 2024, which is herein incorporated by reference in its entirety.

### BACKGROUND

### Field of Invention

The present disclosure relates to a waste drying device and a method for drying waste using the waste drying device.

### Description of Related Art

Solid Recovered Fuel (SRF), as known as SRF fuel rod, is a technology that converts waste into renewable energy. The production process of fuel rods involves drying the pre-screened and crushed waste, and then compressing it into fuel rods. Therefore, if the drying efficiency of the waste drying device could be increased, the production efficiency of fuel rods could be increased.

### SUMMARY

The waste drying device provided by the present disclosure includes an electric heating rod and hollow stirring rods having gas outlet holes. A compressed air from an air compressor is heated using the electric heating rod, and the heated compressed air jets to a waste drying space of a housing through the gas outlet holes of the hollow stirring rods, thereby increasing the drying efficiency of the waste. Furthermore, a debris prevention assembly in the waste drying device can prevent the waste (for example, flying debris) from flying out of the waste drying space, so as to reduce the loss of the waste and avoid clogging of the air outlet.

The housing (including agitator paddles) and the hollow tube (connecting to the hollow stirring rods) of the waste drying device provided by the present disclosure can rotate in opposite directions, so that the waste can be easily loosened and fully turned over, resulting in airflow more easily flowing into the gaps of the waste. When the airflow performs air convection in the waste drying space, it is beneficial to form an aerobic environment in the waste drying space and take away moisture in the waste.

At least one embodiment of the present disclosure provides the waste drying device including a reaction tank, an air compressor, an electric heating rod, and a debris prevention assembly. The reaction tank includes a housing, a hollow tube, and a plurality of hollow stirring rods. The housing has a waste drying space for accommodating an initial waste and a dried waste, wherein the housing is rotatable about a rotation axis of the housing. The hollow tube is disposed on a sidewall of the housing and in the housing, wherein the hollow tube is rotatable about a rotation axis. The hollow stirring rods are disposed on an outer surface of the hollow tube and in the housing and is fluidly connected to the hollow tube and the waste drying space, wherein the hollow stirring rods extend in a radial direction of the hollow tube, and a sidewall of an end portion of each of the hollow stirring rods has a gas outlet hole. The air compressor is fluidly connected to the hollow tube and is configured to provide a compressed air to the hollow tube. The electric heating rod is disposed on the sidewall of the housing and in the hollow tube and is configured to heat the compressed air. The debris prevention assembly is disposed on the housing and fluidly connected to the waste drying space and is configured to prevent the initial waste and/or the dried waste from flying out of the waste drying space.

In one embodiment of the present disclosure, the waste drying device further includes an air flow control and an airmeter. The air flow control is fluidly connected to the air compressor and configured to control a gas flow of the compressed air jetting to the waste drying space. The airmeter is fluidly connected to the air flow control and the hollow tube and is configured to measure the gas flow.

In one embodiment of the present disclosure, the housing includes a plurality of agitator paddles disposed on an inner wall of the housing, wherein the agitator paddles and the hollow stirring rods do not interfere with each other.

In one embodiment of the present disclosure, the debris prevention assembly includes a cavity and a reverse screw. The cavity is disposed on the housing and fluidly connected to the waste drying space, wherein the cavity includes an air outlet on a sidewall of the cavity, wherein the air outlet is fluidly connected to an exterior space outside the housing and the waste drying space. The reverse screw is in the cavity and configured to push the initial waste and/or dried waste to the waste drying space.

In one embodiment of the present disclosure, an inner side of the sidewall of the cavity includes a protrusion, the protrusion includes an impact surface, wherein the impact surface is on a side of the reverse screw and between the housing and the air outlet.

In one embodiment of the present disclosure, the waste drying device further includes a heating device adjacent to the housing.

In one embodiment of the present disclosure, the housing further includes an operating window.

In one embodiment of the present disclosure, the waste drying device further includes a power conditioner connecting to the electric heating rod and configured to adjust a heating temperature of the electric heating rod.

In one embodiment of the present disclosure, the power conditioner is a silicon controlled rectifier.

At least one embodiment of the present disclosure provides a waste drying method including the following steps. The above-mentioned waste drying device is provided. The initial waste is placed in the waste drying space of the waste drying device. The initial waste is rotated and dried to obtain the dried waste. The step of rotating and drying the initial waste includes the following sub-steps. The housing is rotated in a first direction. The hollow tube and the hollow stirring rods are rotated in a second direction, wherein the first direction is opposite to the second direction, and the gas outlet holes face away from the second direction. The compressed air is supplied to the hollow tube using the air compressor. The compressed air from the air compressor is heated using the electric heating rod, wherein the compressed air after heating jets to the waste drying space through the gas outlet holes of the hollow stirring rods.

In one embodiment of the present disclosure, the waste drying device further comprises a heating device adjacent to the housing, and the waste drying method further includes heating the waste drying space using the heating device.

In one embodiment of the present disclosure, a heating temperature of the electric heating rod is 300° C. to 800° C., a gas flow of the compressed air is 300 L/min to 700 L/min, and a heating temperature of the heating device is 40° C. to 60° C.

In one embodiment of the present disclosure, a temperature of the waste drying space is 30° C. to 50° C.

In one embodiment of the present disclosure, the waste drying method further includes before rotating and drying the initial waste, adding an additive to the initial waste, wherein the additive is hydrogen peroxide, lipase, protease, catalase, primary fermentation sugar broth or combinations thereof.

In one embodiment of the present disclosure, the housing is rotated by gear meshing or belt drive.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a side view of a waste drying device in accordance with one embodiment of the present disclosure.

FIG. 2 is an enlarged side view of a debris prevention assembly in FIG. 1.

FIG. 3 is a partial side view of the waste drying device in FIG. 1 from another perspective.

FIG. 4 is a flow chart of a waste drying method in accordance with one embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In the present specification, a range represented by “one value to another value” is a summary representation that avoids enumerating all the values in the range in the specification. Therefore, the recitation of a particular numerical range covers any numerical value within the numerical range and the smaller numerical range defined by any numerical values within the numerical range, as if the arbitrary value and the smaller numerical range are expressly stated in the specification.

A currently known closed-system waste drying device utilizes a heating plate inside the drying device to reduce the moisture content of the waste. However, due to internal circulation, this type of drying device is prone to issues of waste clogging internal components.

The “initial waste” herein may be, for example, municipal solid waste (MSW) or other raw materials suitable for making fuel rods. The “dried waste” herein refers to the dry waste produced after the initial waste is dried. Specifically, the moisture content of the initial waste is greater than the moisture content of the dried waste. The “waste drying space” herein refers to the space used for drying the initial waste. Therefore, the waste drying space may also be understood as a space for accommodating the initial waste and the dried waste. The “fluidly connected to” used herein may be understood as one element being directly adjacent to and physically connected to another element, such that the fluid (for example, air) may communicate between the two elements. The “compressed air” refers to the air that has been compressed by an air compressor to a pressure higher than atmospheric pressure.

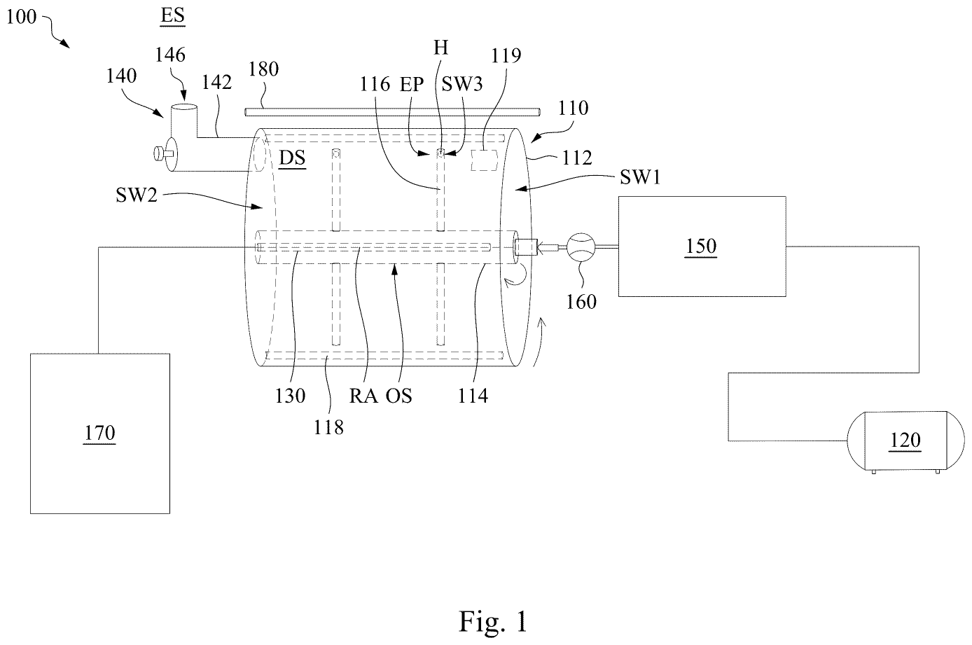

FIG. 1 is a side view of a waste drying device 100 in accordance with one embodiment of the present disclosure. The waste drying device 100 includes a reaction tank 110, an air compressor 120, an electric heating rod 130, and a debris prevention assembly 140. The waste drying device 100 of the present disclosure is suitable for drying the initial waste.

As shown in FIG. 1, the reaction tank 110 includes a housing 112, a hollow tube 114, and a plurality of hollow stirring rods 116. The housing 112 has a waste drying space DS for accommodating the initial waste and the dried waste, wherein housing 112 is rotatable about a rotation axis RA of the housing 112. The housing 112 may be, for example, installed on a support frame (not shown). In some embodiments, the housing 112 may be rotated by gear meshing, belt drive, or other suitable driving methods.

The hollow tube 114 is disposed on at least one sidewall of the housing 112 and in the housing 112, as shown in FIG. 1. For example, the hollow tube 114 is disposed on a sidewall SW1 and a sidewall SW2 of the housing 112, that is, the hollow tube 114 extends from the sidewall SW1 of the housing 112 to the sidewall SW2 of the housing 112. As shown in FIG. 1, the hollow tube 114 is disposed on an axle center of the sidewall SW1 and an axle center of the sidewall SW2 of the housing 112. The hollow tube 114 may rotate along the rotation axis RA of the housing 112, so the hollow tube 114 is coaxially disposed with the housing 112. For example, the hollow tube 114 rotates clockwise or counterclockwise along the rotation axis RA.

The plurality of hollow stirring rods 116 is disposed on an outer surface OS of the hollow tube 114 and in the housing 112, as shown in FIG. 1. These hollow stirring rods 116 extend in a radial orientation of the hollow tube 114. Each of the hollow stirring rods 116 and the hollow tube 114 may be jointed together, for example, by welding or other suitable methods. The hollow stirring rods 116 are fluidly connected to the hollow tube 114 and the waste drying space DS. A sidewall SW3 of an end portion EP of each hollow stirring rod 116 has a gas outlet hole H. Specifically, the hollow stirring rod 116 communicates with the waste drying space DS through the gas outlet hole H.

As shown in FIG. 1, the air compressor 120 is fluidly connected to the hollow tube 114 and is configured to provide a compressed air to the hollow tube 114. In some embodiments, the waste drying device 100 further includes an air flow control 150 and an airmeter 160. The air flow control 150 is between the air compressor 120 and the hollow tube 114 and is fluidly connected to the air compressor 120. The air flow control 150 may control a gas flow of the compressed air jetting to the waste drying space DS. The airmeter 160 is between the air flow control 150 and the hollow tube 114 and is fluidly connected to the air flow control 150 and the hollow tube 114. The airmeter 160 may measure the gas flow of the compressed air provided to the hollow tube 114.

As shown in FIG. 1, the electric heating rod 130 is disposed on the sidewall SW2 of the housing 112 and in the hollow tube 114. As shown in FIG. 1, the electric heating rod 130 is disposed at the axle center of the sidewall SW1 and the axle center of the sidewall SW2 of the housing 112. The electric heating rod 130 is mainly used to heat the compressed air in the hollow tube 114. In some embodiments, the waste drying device 100 further includes a power conditioner 170 connecting to the electric heating rod 130, wherein the power conditioner 170 is configured to adjust a heating temperature of the electric heating rod 130. The power conditioner 170 may be, for example, a silicon controlled rectifier (SCR).

As shown in FIG. 1, the debris prevention assembly 140 is disposed on the housing 112 and is fluidly connected to the waste drying space DS. In some embodiments, the debris prevention assembly 140 is disposed on the sidewall SW2 of the housing 112. The debris prevention assembly 140 is configured to prevent the initial waste and/or dried waste flying out of the waste drying space DS.

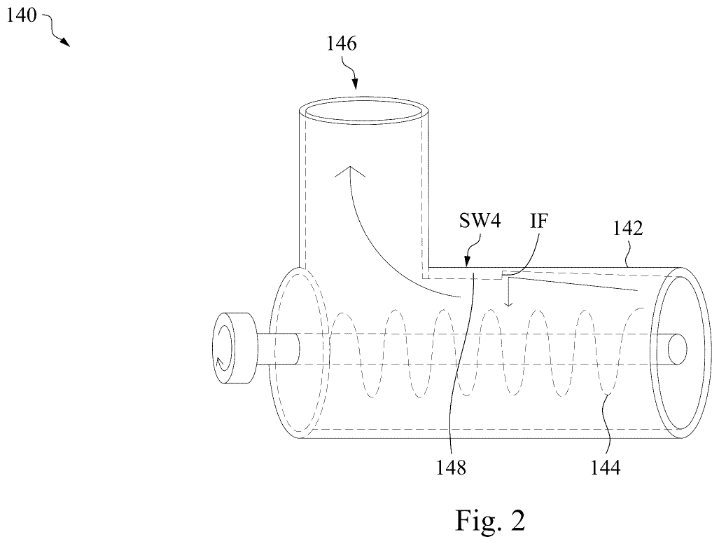

FIG. 2 is an enlarged side view of the debris prevention assembly 140 in FIG. 1. Referring to FIG. 1 and FIG. 2, the debris prevention assembly 140 includes a cavity 142 and a reverse screw 144, wherein the cavity 142 is disposed on the housing 112 and is fluidly connected to the waste drying space DS. In the embodiment of FIG. 1, the cavity 142 is disposed on the sidewall SW2 of the housing 112.

Referring to FIG. 1 and FIG. 2, the cavity 142 includes an air outlet 146 on a sidewall SW4 of the cavity 142, wherein air outlet 146 is fluidly connected to an exterior space ES outside the housing 112 and the waste drying space DS. The reverse screw 144 is in the cavity 142 and is configured to push the initial waste and/or the dried waste flying into the cavity 142 back to the waste drying space DS.

In some embodiments, referring to FIG. 2, an inner side of the sidewall SW4 of the cavity 142 includes a protrusion 148, and the protrusion 148 includes an impact surface IF. Referring to FIG. 1 and FIG. 2, the impact surface IF is on a side of the reverse screw 144 and is between the housing 112 and the air outlet 146. Specifically, the impact surface IF is used to block the waste (including the initial waste and/or the dried waste) flying into the cavity 142 so that the waste will not fly further from the air outlet 146 to the exterior space ES, thereby reducing the loss of the waste. Furthermore, the debris prevention assembly 140 may also prevent the waste from clogging the air outlet 146.

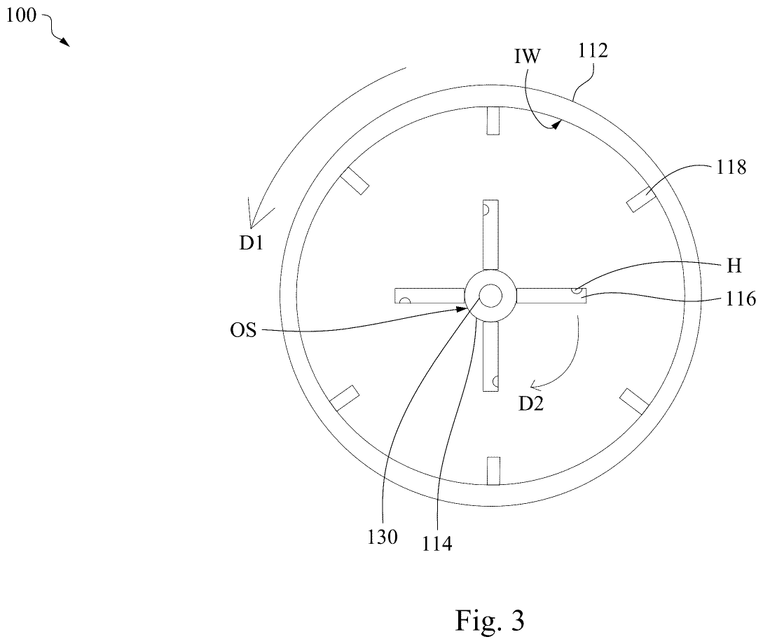

FIG. 3 is a partial side view of the waste drying device 100 in FIG. 1 from another perspective. Referring to FIG. 1 and FIG. 3, the housing 112 includes a plurality of agitator paddles 118 disposed on an inner wall IW of the housing 112. These agitator paddles 118 and these hollow stirring rods 116 do not interfere with each other. As shown in FIG. 1 and FIG. 3, the agitator paddles 118 protrude from the inner wall IW and extend along a direction parallel to the rotation axis RA. Specifically, although the agitator paddles 118 protrude from the inner wall IW, they are still spaced apart from the hollow stirring rods 116. Therefore, when the agitator paddles 118 rotate along the first direction D1 along with the housing 112 and the hollow stirring rods 116 rotate along the second direction D2 along with the hollow tube 114, the agitator paddles 118 and the hollow stirring rods 116 do not contact each other.

Referring to FIG. 1, the waste drying device 100 further includes a heating device 180 adjacent to the housing 112. The heating device 180 is used to heat the waste drying space DS. The heating device 180 is not limited to be disposed above the waste drying device 100. In other embodiments, a plurality of heating device 180 may be disposed around the housing 112. Specifically, the heating device 180 and the reaction tank 110 form a heated pressure chamber that can be continuously pressurized.

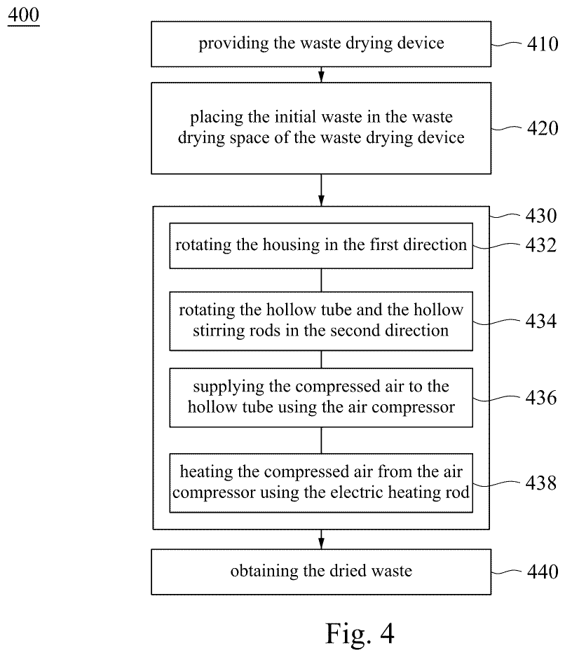

FIG. 4 is a flow chart of a waste drying method 400 in accordance with one embodiment of the present disclosure. First, as shown in a step 410, providing the waste drying device 100 in FIG. 1. Then, as shown in a step 420, referring to FIG. 1, placing the initial waste in the waste drying space DS of the waste drying device 100. After that, as shown in a step 430 and a step 440, rotating and drying the initial waste to obtain the dried waste.

The step 430 of rotating and drying the initial waste includes sub-steps 432, 434, 436, and 438. Referring to FIG. 1, FIG. 3, and FIG. 4, in the sub-step 432, rotating the housing 112 in the first direction D1. In the sub-step 434, rotating the hollow tube 114 and the hollow stirring rods 116 in the second direction D2, wherein the first direction D1 is opposite to the second direction D2, and the gas outlet holes H face away from the second direction D2. In the sub-step 436, supplying the compressed air to the hollow tube 114 using the air compressor 120. In the sub-step 438, heating the compressed air from the air compressor 120 using the electric heating rod 130, wherein the compressed air after heating jets to the waste drying space DS through the gas outlet holes H of the hollow stirring rods 116.

It should be noted that the operation order of the sub-steps 432, 434, 436, and 438 in the step 430 may be adjusted arbitrarily, and some sub-steps may be performed simultaneously with other sub-steps. In a specific example, the sub-steps 436 and 438 may be performed first, and then the sub-steps 432 and 434 may be performed. In another specific example, the sub-steps 432, 434, and 438 may be performed first, and then the sub-step 436 may be performed.

The above-mentioned “first direction” and “second direction” are clockwise or counterclockwise. Specifically, when the first direction is clockwise, the second direction is counterclockwise. Conversely, when the first direction is counterclockwise, the second direction is clockwise. It could be understood that, referring to FIG. 3, because the agitator paddles 118 are disposed on the inner wall IW of the housing 112, the agitator paddles 118 rotate along the first direction D1 when the housing 112 rotates along the first direction D1. Because the hollow stirring rods 116 are disposed on the outer surface OS of the hollow tube 114, the hollow stirring rods 116 rotate along the second direction D2 when the hollow tube 114 rotates along the second direction D2. By rotating the hollow stirring rods 116 and the agitator paddles 118 in opposite directions, the waste (including the initial waste and the dried waste) undergoes thorough turning to enhance its dispersibility.

Referring to FIG. 1 and FIG. 2, it could be understood that, when the initial waste with high moisture content gradually becomes the dry waste with low moisture content due to the drying process, the dry waste may fly away from the waste drying space DS into the cavity 142 of the debris prevention assembly 140 due to its light weight. In addition, as the housing 112 continuously rotates, heavier initial waste may also move into the cavity 142 of the debris prevention assembly 140. When the waste (including the initial waste and the dried waste) in the cavity 142 hits the impact surface IF, the waste will fall down into the reverse screw 144. At this time, the reverse screw 144 continuously rotates to push the waste back to the waste drying space DS. Therefore, compared with a waste drying device without the debris prevention assembly 140, the waste drying device 100 of the present disclosure can reduce waste loss, for example, reduce waste loss by 70% to 90%.

Referring to FIG. 3, it is worth nothing that, because the air outlet holes H on the hollow stirring rods 116 face away from the second direction D2, the waste (including the initial waste and the dried waste) will not clog the air outlet holes H, thereby improving the drying efficiency of the waste drying device 100.

The waste drying device 100 of the present disclosure is an open system. Specifically, the heated compressed air entering the waste drying space DS can be discharged from the air outlet 146 of the debris prevention assembly 140, so that the air in the reaction tank 110 and the air outside the reaction tank 110 maintain convection, which is beneficial to remove moisture in the waste, thereby improving the drying efficiency of the waste drying device 100. In other words, the pressure in the reaction tank 110 is normal pressure. Air convection is also beneficial to the aerobic growth of microorganisms and bacteria in the waste in the reaction tank 110. In addition, the heated compressed air applied to the waste drying space DS can loosen the waste and reduce the moisture in the waste, and it can also cause the microorganisms and bacteria in the waste to grow aerobically, which is beneficial to decomposing organic matter in the waste, thereby purifying the waste.

In some embodiments, referring to FIG. 1, the waste drying method 400 further includes heating the waste drying space DS using the heating device 180. Specifically, the heating device 180 is used to increase or maintain the temperature of the waste drying space DS. In some specific embodiments, a heating temperature of the heating device 180 is 40° C. to 60° C., such as 50° C. In some specific embodiments, a temperature of the waste drying space DS is 30° C. to 50° C., such as 35° C., 40° C., or 45° C. When the heating temperature of the heating device 180 and the temperature of the waste drying space DS are in the above ranges, it is beneficial to increase the drying efficiency of the waste drying device 100.

In some specific embodiments, the heating temperature of the electric heating rod 130 is 300° C. to 800° C., such as 400° C., 500° C., 600° C., or 700° C. The electric heating rod 130 is configured to heat the compressed air. When the heating temperature of the electric heating rod 130 is in the above range, it is beneficial to increase the drying efficiency of the waste drying device 100.

In some specific embodiments, the gas flow of the compressed air is 300 L/min to 700 L/min, such as 400 L/min, 500 L/min, or 600 L/min. The gas flow of the compressed air further affects the degree of waste loosening and the extent of moisture removal. When the gas flow of the compressed air is in the above range, it is beneficial to increase the drying efficiency of the waste drying device 100.

In some embodiments, the waste drying method 400 may optionally add an additive to the initial waste before turning and drying the initial waste (that is, the step 430), wherein the additive is hydrogen peroxide, lipase, protease, catalase, primary fermentation sugar broth or combinations thereof. Adding the additive helps to increase the temperature of the waste drying space DS, which is beneficial to increase the drying efficiency of the waste drying device 100. Furthermore, adding the additive also helps to ferment the waste to reduce the odor of the waste.

In some specific embodiments, based on a weight of the initial waste as 100 weight percent, a content of the primary fermentation sugar broth is 1 weight percent to 4 weight percent, such as 2 weight percent or 3 weight percent. In some specific embodiments, a concentration of the primary fermentation sugar broth 20 wt. % to 50 wt. %. When the content and the concentration of the primary fermentation sugar broth is in the above ranges, it is beneficial to ferment the waste and reduce the odor of the waste. In some specific embodiments, based on a weight of the initial waste as 100 weight percent, the content of the additive is 0.5 weight percent to 2 weight percent, such as 1 weight percent.

Referring to FIG. 1, the housing 112 of the waste drying device 100 further includes an operating window 119. The operating window 119 may be used to place the initial waste in the waste drying space DS, take out the dried waste from the waste drying space DS, and measure the temperature of the waste drying space DS. It could be understood that the operating window 119 remains closed during the drying process of the waste. In some embodiments, the temperatures of the front section, the middle section, and the rear section of the waste drying space DS in the reaction tank 110 may be measured from the operating window 119. In some embodiments, the humidity of the waste drying space DS in the reaction tank 110 may be measured by a hygrometer at the air outlet 146 of the debris prevention assembly 140.

In the waste drying method 400 of the present disclosure, by using heated compressed air, rotating the housing 112 in the first direction D1, and rotating the hollow tube 114 and the plurality of hollow stirring rods 116 in the second direction D2 to increase the dispersibility of the waste, thereby improving the drying efficiency of the waste drying device 100. The dried waste may be further made into fuel rods. For example, the fuel rods may be added to coal-fired boilers to reduce sulfide in the coal-fired boilers, but it is not limited to this application.

The following Experimental Examples are used to describe the applications of the present disclosure, but they are not intended to limit the present disclosure. Those skilled in the art may make various changes and alterations herein without departing from the spirit and scope of the present disclosure.

### Experimental Example 1

First, the initial waste was placed in the waste drying space DS of the waste drying device 100, wherein the initial waste weight was 20 kg. Then, the initial waste was rotated and dried to obtain the dried waste of Experimental Example 1, wherein the heating temperature of the electric heating rod 130 was 300° C., and the gas flow of the compressed air was 600 L/min. During the process of the waste, the moisture content and temperature of the waste were measured every hour. The measurement results were shown in Table 1 below.

### Experimental Example 2

Experimental Example 2 was performed in a manner similar to Experimental Example 1, except that the additive was added to the initial waste before rotating and drying the initial waste. Based on a weight of the initial waste as 100 weight percent, the content of the additive includes 30 wt. % to 35 wt. % of the primary fermentation sugar broth and 0.03 wt. % to 0.05 wt. % of the hydrogen peroxide, wherein a total weight of the primary fermentation sugar broth and hydrogen peroxide was 500 g. The moisture content and temperature of the waste were measured every hour. The measurement results were shown in Table 1 below.

TABLE 1

| | Experimental Example 1 | | Experimental Example 2 | |
|---|---|---|---|---|
| | without additive | | with additive | |
| | Moisture | | Moisture | |
| Testing | content | Temperature | content | Temperature |
| time (hr) | (%) | (° C.) | (%) | (° C.) |
| 0 | 53.29 | 25.70 | 62.93 | 29.17 |
| 1 | 49.40 | 25.30 | 61.34 | 29.03 |
| 2 | 48.53 | 26.23 | 56.37 | 32.27 |
| 3 | 47.41 | 27.90 | 55.10 | 31.20 |
| 4 | 44.96 | 27.63 | 33.82 | 33.23 |
| 5 | 43.72 | 28.63 | 43.42 | 32.20 |
| 6 | 47.30 | 28.80 | 43.65 | 32.57 |
| 7 | 41.06 | 28.20 | 37.64 | 32.40 |

It could be known from Table 1 that, compared with Experimental Example 1, Experimental Example 2 could increase the temperature of the waste drying space DS by about 4° C., and could also increase the heating rate of the waste drying space DS.

In summary, the waste drying device provided by the present disclosure includes the electric heating rod and the hollow stirring rods having gas outlet holes. The compressed air from the air compressor is heated using the electric heating rod, and the heated compressed air jets to the waste drying space of the housing through the gas outlet holes of the hollow stirring rods, thereby increasing the drying efficiency of the waste. Furthermore, the debris prevention assembly in the waste drying device can prevent the waste (for example, flying debris) from flying out of the waste drying space, so as to reduce the loss of the waste.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A waste drying device, comprising:
a reaction tank, comprising:
a housing having a waste drying space for accommodating an initial waste and a dried waste, wherein the housing is rotatable about a rotation axis of the housing;
a hollow tube disposed on a sidewall of the housing and in the housing, wherein the hollow tube is rotatable about a rotation axis; and
a plurality of hollow stirring rods disposed on an outer surface of the hollow tube and in the housing and fluidly connected to the hollow tube and the waste drying space, wherein the hollow stirring rods extend in a radial direction of the hollow tube, and a sidewall of an end portion of each of the hollow stirring rods has a gas outlet hole;
an air compressor fluidly connected to the hollow tube and configured to provide a compressed air to the hollow tube;
an electric heating rod disposed on the sidewall of the housing and in the hollow tube and configured to heat the compressed air; and
a debris prevention assembly disposed on the housing and fluidly connected to the waste drying space and configured to prevent the initial waste and/or the dried waste from flying out of the waste drying space.

2. The waste drying device of claim 1, further comprising:
an air flow control fluidly connected to the air compressor and configured to control a gas flow of the compressed air jetting to the waste drying space; and
an airmeter fluidly connected to the air flow control and the hollow tube and configured to measure the gas flow.

3. The waste drying device of claim 1, wherein the housing comprises a plurality of agitator paddles disposed on an inner wall of the housing, wherein the agitator paddles and the hollow stirring rods do not interfere with each other.

4. The waste drying device of claim 1, wherein the debris prevention assembly comprises:
a cavity disposed on the housing and fluidly connected to the waste drying space, wherein the cavity comprises an air outlet on a sidewall of the cavity, wherein the air outlet is fluidly connected to an exterior space outside the housing and the waste drying space; and
a reverse screw in the cavity and configured to push the initial waste and/or the dried waste back to the waste drying space.

5. The waste drying device of claim 4, wherein an inner side of the sidewall of the cavity comprises a protrusion, the protrusion comprises an impact surface, wherein the impact surface is on a side of the reverse screw and between the housing and the air outlet.

6. The waste drying device of claim 1, further comprising a heating device adjacent to the housing.

7. The waste drying device of claim 1, wherein the housing further comprises an operating window.

8. The waste drying device of claim 1, further comprising a power conditioner connecting to the electric heating rod and configured to adjust a heating temperature of the electric heating rod.

9. The waste drying device of claim 8, wherein the power conditioner is a silicon controlled rectifier.

10. A waste drying method, comprising:
providing the waste drying device of claim 1;
placing the initial waste in the waste drying space of the waste drying device; and
rotating and drying the initial waste to obtain the dried waste, comprising:
rotating the housing in a first direction;
rotating the hollow tube and the hollow stirring rods in a second direction, wherein the first direction is opposite to the second direction, and the gas outlet holes face away from the second direction;
supplying the compressed air to the hollow tube using the air compressor; and
heating the compressed air from the air compressor using the electric heating rod, wherein the compressed air after heating jets to the waste drying space through the gas outlet holes of the hollow stirring rods.

11. The waste drying method of claim 10, wherein the waste drying device further comprises a heating device adjacent to the housing, and the waste drying method further comprises heating the waste drying space using the heating device.

12. The waste drying method of claim 11, wherein a heating temperature of the electric heating rod is 300° C. to 800° C., a gas flow of the compressed air is 300 L/min to 700 L/min, and a heating temperature of the heating device is 40° C. to 60° C.

13. The waste drying method of claim 10, wherein a temperature of the waste drying space is 30° C. to 50° C.

14. The waste drying method of claim 10, further comprising:
before rotating and drying the initial waste, adding an additive to the initial waste, wherein the additive is hydrogen peroxide, lipase, protease, catalase, primary fermentation sugar broth or combinations thereof.

15. The waste drying method of claim 10, wherein the housing is rotated by gear meshing or belt drive.

16. The waste drying method of claim 10, wherein the debris prevention assembly comprises:
a cavity disposed on the housing and fluidly connected to the waste drying space, wherein the cavity comprises an air outlet on a sidewall of the cavity, wherein the air outlet is fluidly connected to an exterior space outside the housing and the waste drying space; and
a reverse screw in the cavity and configured to push the initial waste and/or the dried waste back to the waste drying space.
